(19) United States
(12) Patent Application Publication
(10) Pub. No.: US 2026/0192677 A1
(43) Pub. Date: Jul. 9, 2026

(54) ELECTRICAL INSTALLATION WITH MEANS FOR SWITCHING SERIES ELECTRIC ARCS

(71) Applicant: SAFRAN ELECTRICAL & POWER, Blagnac (FR)

(72) Inventor: Eric GUILLARD, Moissy-Cramayel (FR)

(21) Appl. No.: 19/131,172

(22) PCT Filed: Nov. 20, 2023
(86) PCT No.: PCT/FR2023/051821

§ 371 Date: May 19, 2025

(30) Foreign Application Priority Data
Nov. 25, 2022 (FR) FR2212326

(51) Int. Cl. B60L 3/04; H01H 9/38; H01H 9/42; H01H 33/59; H01H 37/00

(52) U.S. Cl. CPC B60L 3/04; H01H 9/38; H01H 9/42; H01H 33/596; H01H 37/002; B60L 2200/10

(57) ABSTRACT

The apparatus includes a power source; an electrical load; first and second supply lines connecting the electrical load to the power source, with a view to supplying electrical power to the electrical load; and a power contactor located on the first supply line. The apparatus further includes a branch parallel to the first supply line, connected between two points (A, B) of the first supply line these two points (A, B) surrounding the power contactor; on this branch an auxiliary contact connected to the power contactor and intended to open before and close after the power contactor; and a device for opening, depending on a current flowing through the branch, one of the supply lines.

### TECHNICAL FIELD OF THE INVENTION

The present invention relates to an electrical installation with means for switching series electric arcs, as well as to an aircraft comprising such an electrical installation.

### TECHNICAL BACKGROUND

Vertical Take Off and Landing (VTOL) aircraft and Conventional Take Off and Landing (CTOL) aircraft with electric or hybrid propulsion represent a future market with significant prospects and demand for intra-urban and inter-urban transport of goods and people.

The propulsion of these different platforms is carried out by one or more electric motors, the number varying according to the architectures of the aircrafts. These electric propulsion systems use ever higher voltage levels.

The failure modes of these systems show that the appearance of a series electric arc may have serious consequences on the aircraft structures if the latter is not stopped.

In an installation using propulsive electrical power, one or more of the following functions may be used to provide power to the aircraft:
an energy storage system, for example in the form of batteries,
a Battery Management System (BMS) configured to manage the charging and discharging of the cells of the batteries,
a distribution and protection equipment for the supply chain, and
a propulsion converter assembly configured to convert electrical energy into mechanical energy.

Detecting series electric arcs in an on-board power supply, particularly at the level of a contactor, often requires the use of dedicated elements, which may be complex.

It may therefore be desirable to provide an electrical installation with means for switching series electric arcs, which avoids at least some of the aforementioned problems and constraints.

### SUMMARY OF THE INVENTION

An electrical installation for an aircraft is therefore proposed, comprising:
a electrical source;
an electrical load;
first and second supply lines connecting the electrical load to the electrical source for supplying electrical power to the electrical load; and
a power contactor located on the first supply line;
   characterized in that it further comprises:
a branch parallel to the first supply line, connected between two points of the first supply line, these two points surrounding the power contactor;
on this branch, an auxiliary contact connected to the power contactor to open before and close after the power contactor; and
a device for opening one of the supply lines depending on a current flowing the branch.

The invention thus allows to detect the occurrence of a series electric arc between the two points of the first supply line, and in particular on the power contactor. In fact, the series electric arcs causes a voltage drop, resulting in a current flowing in the parallel branch. In response to this current, the opening device opens one of the supply lines, which switch off the series electric arc, i.e. stops it. Moreover, when the power contactor is open, the auxiliary contact is also open, preventing any current flow that may inadvertently trigger the current cut-off system. With the power contactor open, the electrical source applies a voltage between the two points which, without the auxiliary contact open, would lead to an undesirable flow of current in the parallel branch.

The invention may also comprise one or more of the following optional characteristics, in any technically possible combination.

Preferably, the opening device comprises a pyrotechnic switch located on one of the supply lines, the pyrotechnic switch comprising a resistor located on the branch, in series with the auxiliary contact.

Preferably also, the pyrotechnic switch is also preferably designed to cut the first supply line outside the two points.

Preferably also, the auxiliary contact is designed to close with a time delay relative to the power contactor.

Preferably also, the opening device comprises a power contactor located on the first electrical line or on the second electrical line.

Preferably also, the electrical installation comprises a time delay resistor located on the branch, in series with the auxiliary contact.

Preferably also, the detection device additionally comprises a device for suppressing current in the branch, located on the branch in series with the auxiliary contact and designed to prevent a flow of current in the branch when it has a voltage below a certain trigger threshold and to allow the flow of current when the voltage is above this trigger threshold.

Preferably also, the trigger threshold is lower than a voltage which the electrical source is designed to supply.

Preferably also, the electrical load comprises an electrical machine for driving a fan of the aircraft.

An aircraft comprising an electrical installation according to the invention is also proposed.

### BRIEF DESCRIPTION OF THE FIGURES

The invention will be better understood with the aid of the following description, given only by way of example and made with reference to the attached drawings wherein:

FIG. 1 is an electrical diagram of an example of an electrical installation according to the invention,

FIG. 2 is a block diagram of an example of a method for operating the installation shown in FIG. 1,

FIG. 3 shows the electrical diagram of FIG. 1 in the event of a series electric arc following the melting of a fuse in the electrical installation, and

FIG. 4 shows the electrical diagram of FIG. 1 in the event of a series electric arc occurring in a power contactor in the electrical installation.

### DETAILED DESCRIPTION OF THE INVENTION

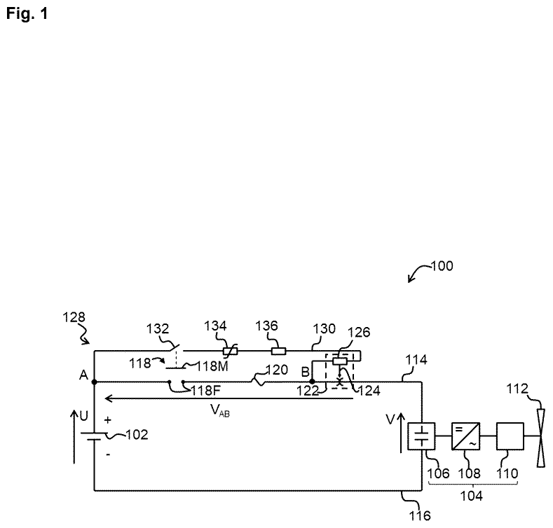

With reference to FIG. 1, an example of an electrical installation 100 according to the invention will now be described.

The electrical installation 100 is designed to form part of an aircraft.

The electrical installation 100 firstly comprises an electrical source 102, for example a DC electrical source such as a battery. The electrical source 102 is thus designed to supply a voltage U, which may be DC.

The electrical installation 100 also comprises an electrical load 104 designed to receive a voltage V, for example DC. For example, the electrical load 104 comprises a stage 106 for smoothing the DC voltage V, a DC/AC voltage converter 108 for converting the smoothed voltage V into an AC voltage and an electrical machine 110 for driving a fan 112 of the aircraft (for example a propeller) from the AC voltage.

The electrical installation 100 also comprises first and second supply lines 114, 116 each connecting the electrical load 104 to the electrical source 102 to supply electrical power to the electrical load 104 from the electrical source 102.

The electrical installation 100 also comprises a power contactor 118 located on one of the supply lines 114, 116. The power contactor 118 comprises at least one fixed contact and one movable contact designed to come into contact with the fixed contact or contacts when the power contactor 118 is closed, and to move away from them when the contactor 118 is open. For example, as in the example shown, the power contactor 118 is double-break and comprises two fixed contacts 118F and a movable vane 118M acting as a movable contact designed to come into contact with the two fixed contacts 118F.

The electrical installation 100 also comprises a fuse 120 located on one of the supply lines 114, 116.

The electrical installation 100 also comprises a pyrotechnic switch 122 (pyroswitch) located on one of the supply lines 114, 116. The pyrotechnic switch 122 comprises a guillotine 124, an initialisation resistor 126 and a pyrotechnic element (not shown) designed to be triggered under the effect of the heat released by the initialisation resistor 126.

The purpose of triggering the pyrotechnic element is to propel the guillotine 124 so that the latter mechanically cuts the supply line (the first supply line in the example shown). The initialisation resistor 126 is thus designed to have a current flowing through it to heat it up and thus provide the heat required to trigger the pyrotechnic element.

The electrical installation 100 also comprises a device 128 for detecting a series electric arc.

The detection device 128 comprises a branch 130 connected between two points A, B of the first supply line 114. It is between these two points A, B that the detection device 128 is designed to detect a series electric arc. Thus, in order to monitor the greatest possible length of the first supply line 114, the points A and B are preferably located as close as possible to the electrical source 102 and the electrical load 104 respectively. In this way, it is possible to detect a series electric arc appearing on the power contactor 118 or a series electric arc caused by a cable damage in any section between the points A and B, for example appearing as a result of the fuse 120 melting. The pyrotechnic switch 122 may be designed to cut the supply line 114 outside the two points A, B as shown in FIG. 1, but this is not compulsory.

In the case where the electrical load 104 comprises the electrical machine 110 coupled to the fan 112, the pyrotechnic switch 122 is preferably designed to cut the first supply line 114 as close as possible to the electrical machine 110. In fact, the latter may become a generator when it is disconnected from the electrical source 102 and may therefore supply other loads connected between the supply lines 114, 116.

The detection device 128 also comprises, in series on the branch 130: an auxiliary contact 132, a current suppression device 134, a delay resistor 136 and the initialisation resistor 126 of the pyrotechnic switch 122. The order of these elements on the branch 130 may be arbitrary, as long as the initialisation resistor 126 is the last, i.e. the closest to the point B. The device 134 for suppressing current in the branch 130 is designed to prevent a current flow in the branch 130 when it has a voltage below a certain trigger threshold and to allow the current flow when the voltage is above this trigger threshold. This may be a varistor or a Transient Voltage Suppression (TVS) device.

The auxiliary contact 132 is connected to the power contactor 118 to open and close with the power contactor 118, and more specifically to open ahead of and close behind the power contactor 118. The connection between the auxiliary contact 132 and the power contact 118 is preferably mechanical only.

When the elements of the first supply line 114 have a negligible voltage drop (as in the illustrated example, where the main contactor 118 has a very low voltage drop), the voltage of the current suppression device 134 is substantially equal to the voltage drop V_{AB} between the two points A and B. In the absence of series electric arc between these two points A and B, the voltage drop V_{AB} is mainly due to the voltage drop of the first supply line 114 between the two points A and B. The trigger threshold of the current suppression device 134 is therefore chosen to be greater than the voltage drop V_{AB} expected in normal operation, for example greater than at least 5 V to avoid unwanted detections. For example, the trigger threshold is chosen to be equal to or much less than the sum of the voltage drop V_{AB} expected in normal operation and the voltage at which a series electric arc occurs. For example, if the voltage drop expected in normal operation is at most 5 V and the voltage at which a series electric arc occurs is 17 V, they add up to 22 V. The trigger threshold is therefore preferably chosen between 5 V and 22 V, for example 20 V. With the voltage drops generally found in the supply lines used in aeronautics, the varistor trigger threshold is preferably at most 30 V.

The delay resistor 136 limits the current flowing through the initialisation resistor 126 and therefore slows down the heating of the latter. This prevents the pyrotechnic switch 122 from being triggered by a transient series electric arc which disappears spontaneously very quickly after it appears. In some cases, in particular when the delay inherent in the initialisation resistor 126 is deemed sufficient, the delay resistor 136 may be omitted.

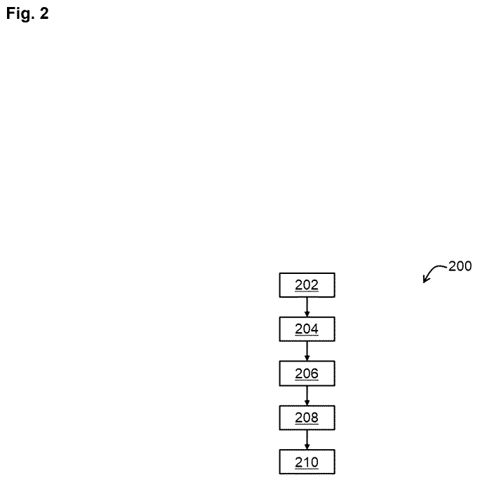

With reference to FIG. 2, an example of a method 200 for operating the electrical installation 100 will now be described.

The power contactor 118 is initially open, as is the auxiliary contact 132. In this way, the electrical load 104 is disconnected from the electrical source 102, so that its voltage V is zero and no current flows in the supply lines 114, 116. In addition, the open state of the auxiliary contact 132 prevents an accidental triggering of the pyrotechnic switch 122. Indeed, if the auxiliary contact 132 were not present, the voltage U present between points A and B would cause a current to flow in the branch 130 and therefore in particular in the initialisation resistor 126, which would lead to the pyrotechnic switch 122 being triggered.

During a step 202, the power contactor 118 is closed. The electrical source 102 supplies power to the electrical load 104 so that a current flows through the supply lines 114, 116.

In a step 204, after the power contactor 118 has closed, the auxiliary contact 132 closes.

In the absence of series electric arcs, the voltage drop on the first supply line 114 is very low. More specifically, the voltage drop across the power contactor 118 is, for example, less than 150 mV, the voltage drop across the fuse 120 is, for example, less than 150 mV and the voltage drop across the wiring of the first supply line 114 between the points A and B is, for example, less than 5 V. Thus, there is a voltage V_{AB} of a few volts at most between the points A and B, resulting mainly from the voltage drop in the first supply line 114 between the points A and B. In any case, the voltage V_{AB} is less than the trigger voltage of the current suppression device 134. The latter is therefore in the open state and prevents a current flow in the branch 128 and therefore a triggering of the pyrotechnic switch 122.

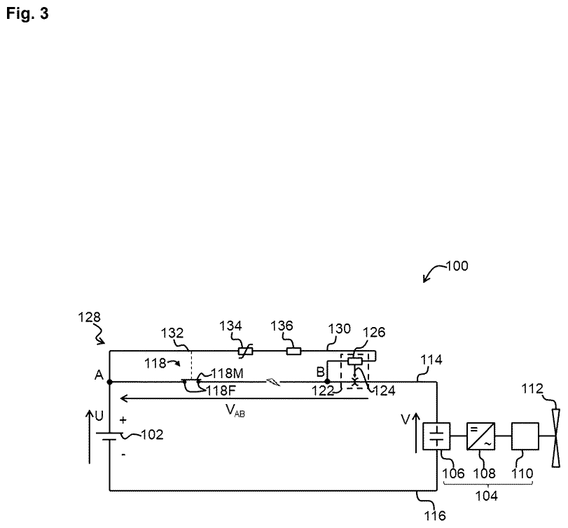

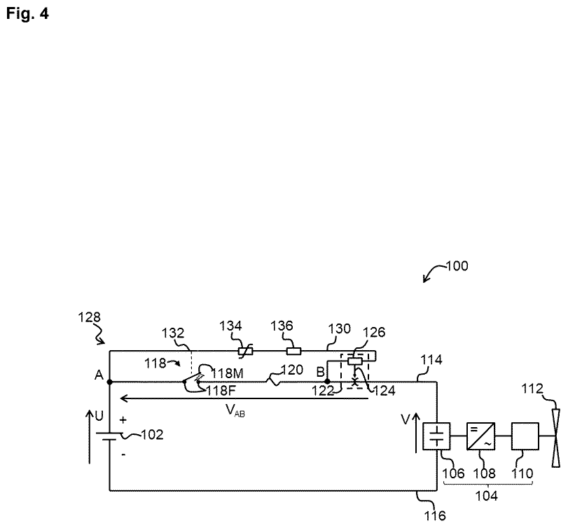

During a step 206, a series electric arc appears on the first supply line 114, between the points A and B. The series electric arc is caused, for example, by a melting of the fuse 120 and appears in place of the fuse 120, as shown in FIG. 3. Alternatively, the series electric arc may occur in the power contactor 118 if it is incorrectly closed. For example, a space may remain between one of the fixed contacts 118F and the movable vane 118M, the series electric arc then extending into this space, as shown in FIG. 4.

As explained in André Thibault's thesis entitled “Étude des mécanismes d'entretien et de propagation d'un arc électrique de court-circuit entre câbles endommagés dans les réseaux électriques d'aéronefs”, available on the HAL platform with the identifier tel-01804832, the series electric arc presents a voltage drop of a few volts at its onset, for example of at least 15 V to 20 V.

The voltage drop of the series electric arc is added to that of the first supply line 114 between the points A and B (the other elements have a negligible voltage drop). In addition, as the length of the series electric arc increases (for example, when the fuse melts or disintegrates), the voltage drop across the series electric arc may increase, and therefore also the voltage drop V_{AB} between the points A and B.

During a step 208, the device 134 becomes conductive because the voltage drop V_{AB} between the points A and B exceeds the trigger voltage of the device 134. A current flows through the branch 130 and in particular through the initialisation resistor 126, which begins to heat up. This current increases over time as the voltage drop of the series electric arc increases.

During a step 210, the heat generated by the initialisation resistor 126 becomes sufficiently high to trigger the pyrotechnic switch 122, which cuts off the first supply line 114 and thus stops the series electric arcs.

The suppression by the pyrotechnic switch 122 of the electric arc from a trigger of the fuse 120, allows to avoid reinjecting energy into the network (windmilling) if the pyrotechnic switch 122 is located near the electrical load 104, in particular the electrical propulsion machine 110.

In particular, when the length between the points A and B is not too great, the varistor 132 may be omitted. In this case, the voltage drop due to the length of the line between the points A and B becomes small, for example a few hundred millivolts. Thus, the voltage drop V_{AB} between the points A and B, in the absence of series electric arc, is small, for example less than 1 V. This voltage drop V_{AB} does create a current flowing in the branch 130, but it is too small to trigger the pyrotechnic switch 122. On the other hand, if a series electric arc occurs between the points A and B, the voltage drop V_{AB} becomes high, and the resulting current in the branch 130 leads to the triggering of the pyrotechnic switch 122.

In conclusion, it should be noted that the invention is not limited to the embodiments described above. In fact, it will appear to the person skilled in the art that various modifications may be made to the above-described embodiments, in the light of the teaching just disclosed.

For example, the first supply line 114 may be opened to suppress the series electric arc, for example instead of or in addition to triggering the pyrotechnic switch 122, by opening the power contactor 118.

In addition, the current suppression device 134 may be done by an electronic measurement system, instead of the varistor or TVS.

In addition, the auxiliary contact 132 may be an electronic or electromechanical switching device.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. An electrical installation for an aircraft, comprising:
an electrical source;
an electrical load;
first and second supply lines, connecting the electrical load to the electrical source with a view to supplying electrical power to the electrical load; and
a power contactor located on the first supply line;
wherein the electrical installation further comprises:
a branch parallel to the first supply line connected between two points (A, B) of the first supply line these two points (A, B) surrounding the power contactor;
on this branch, an auxiliary contact connected to the power contactor to open before and close after the power contactor; and
a device for opening one of the supply lines in response to an occurrence of a current flowing in the parallel branch resulting from an occurrence of series electric arc between the two points (A, B) of the first supply line.

2. The electrical installation according to claim 1, wherein the opening device comprises a pyrotechnic switch located on one of the supply lines, the pyrotechnic switch comprising an initialization resistor located on the branch, in series with the auxiliary contact.

3. The electrical installation according to claim 2, wherein the pyrotechnic switch is designed to cut the first supply line outside the two points (A, B).

4. The electrical installation according to claim 1, wherein the power source is designed to supply a DC voltage (U).

5. The electrical installation according to claim 1, wherein the opening device comprises a power contactor located on the first electrical line or on the second electrical line.

6. The electrical installation according to claim 1, further comprising a time delay resistor located on the branch, in series with the auxiliary contact.

8. The electrical installation according to claim 1, wherein the detection device additionally comprises a device (134) for suppressing current in the branch, located on the branch in series with the auxiliary contact and designed to prevent a flow of current in the branch when it has a voltage below a certain trigger threshold and to allow the flow of current when the voltage is above this trigger threshold.

8. The electrical installation according to claim 7, wherein the trigger threshold is lower than a voltage (U) which the electrical source is designed to supply.

9. The electrical installation according to claim 1, wherein the electrical load comprises an electrical machine for driving a fan of the aircraft.

10. An aircraft comprising an electrical installation according to claim 1.
